(19) United States
(12) Patent Application Publication
(10) Pub. No.: US 2015/0228427 A1
(43) Pub. Date: Aug. 13, 2015

(54) CIRCUIT BREAKER OF GAS-INSULATED SWITCHGEAR WITH FIXED PART OF DECREASED LENGTH

(71) Applicant: HYUNDAI HEAVY INDUSTRIES CO., LTD., Ulsan (KR)

(72) Inventor: Hyung-Choon KIM, Ulsan (KR)

(21) Appl. No.: 14/577,403

(22) Filed: Dec. 19, 2014

(30) Foreign Application Priority Data
Feb. 7, 2014 (KR) 10-2014-0014175

(51) Int. Cl. H01H 33/70; H01H 33/12

(52) U.S. Cl. CPC H01H 33/7076; H01H 33/7038; H01H 33/7061; H01H 33/121

(57) ABSTRACT

A circuit breaker of a gas-insulated switchgear includes a movable part conductor, a fixed part conductor, and a movable rod part which is moved between them to be positioned in an inserted state and an interrupting state. The fixed part conductor includes a fixed part conductor pipe which has a cylindrical shape, a fixed part arc contact which is fastened to a center shaft of the fixed part conductor pipe, a support which fastens the fixed part arc contact to the fixed part conductor pipe, and a support shield which covers a surface of the support.

### CROSS REFERENCE TO RELATED APPLICATION

This application claims the benefit of Korean patent application no. 10-2014-0014175, filed on Feb. 7, 2014, entitled “CIRCUIT BREAKER OF GAS-INSULATED SWITCHGEAR WITH FIXED PART OF DECREASED LENGTH”, which is hereby incorporated by reference in its entirety into this application.

### BACKGROUND

1. Technical Field

The present disclosure relates to a circuit breaker for a gas-insulated switchgear, and more particularly, to a circuit breaker for a gas-insulated switchgear, which allows the length of a fixed part conductor to be decreased.

2. Related Art

A gas-insulated switchgear (GIS) refers to a switching system in which switching units such as a circuit breaker and a disconnecting switch, a transformer, a lightning arrestor, a main bus bar, and so on are collectively received in a metal tank, charging parts are supported by spacers, an SF6 gas with excellent insulation and arc extinction performance is filled in the interior of the tank, and the tank is then sealed.

The main pressure-resistant components of the GIS include a gas circuit breaker, an earthing switch, a lightning arrestor, a potential transformer, a current transformer, and so forth.

The operating duties of the circuit breaker used in a GIS are specified in the IEC standard. In general, the rated operating sequence of ‘O-0.3 s-CO-3 min-CO’ is observed.

Basically, in a circuit breaker, interrupting performance is required two times within 0.3 second. Since a first interruption duty is performed in the state in which the SF6 gas is in a cool gas state, the interrupting performance is excellent. Upon interruption, the temperature of the surrounding SF6 gas rises to 20,000° C. to 30,000° C. within a short time by a generated arc. A second interruption duty after 0.3 second is performed in the state in which the interior of the circuit breaker has a high temperature and a high pressure. Since the interrupting performance of the SF6 gas at the high temperature is abruptly degraded, it is difficult to interrupt fault current.

A related art is disclosed in Korean Unexamined Patent Publication No. 10-2006-0116567 (published on Nov. 15, 2006) entitled ‘H/V interrupter with suction type arc quenching system’.

### SUMMARY

Various embodiments are directed to a circuit breaker for a gas-insulated switchgear which prevents the ablation of a support supporting a fixed part arc contact from a high-temperature and high-pressure arc extinction gas when interrupting fault current, thereby reducing the generation of metal particles and suppressing grounding and short-circuiting due to metal particles.

Also, various embodiments are directed to a circuit breaker for a gas-insulated switchgear which prevents the support from being damaged by arc heat, thereby allowing the length of a fixed part to be decreased.

In an embodiment, a circuit breaker of a gas-insulated switchgear may includes a movable part conductor, a fixed part conductor, and a movable rod part which is moved between them to be positioned in an inserted state and an interrupting state, wherein the fixed part conductor may include a fixed part conductor pipe which has a cylindrical shape, a fixed part arc contact which is fastened to a center shaft of the fixed part conductor pipe, a support which fastens the fixed part arc contact to the fixed part conductor pipe, and a support shield which covers a surface of the support.

The support shield may cover a front surface of the support which faces an arc, and both side surfaces of the support.

Two supports may be disposed with an angle of 180°, or three supports may be disposed with an angle of 120°.

The support shield may be formed of a material which has a melting point higher than a material of the support. For example, the support may be formed of an aluminum alloy, and the support shield may be formed of copper or steel.

The front surface of the support may have a round shape or a triangular cross-sectional shape, and the support shield may cover the front surface and both side surfaces of the support, in correspondence to the shape of the front surface.

Both side surfaces of the support shield may be formed to protrude from a rear surface of the support.

### BRIEF DESCRIPTION OF THE DRAWINGS

FIG. 1 is an exploded cross-sectional view illustrating the structure of a circuit breaker which is provided in a gas-insulated switchgear.

FIG. 2 is a cross-sectional view illustrating the inserted state of the circuit breaker.

FIG. 3 is a cross-sectional view illustrating the interrupting state of the circuit breaker.

FIGS. 4a and 4b are of cross-sectional views illustrating the structure of a conventional fixed part.

FIGS. 5a and 5b are of cross-sectional views illustrating the structure of a fixed part in accordance with an embodiment.

### DETAILED DESCRIPTION

Hereinafter, a circuit breaker of a gas-insulated switchgear with a fixed part of a decreased length will be described in detail with reference to the accompanying drawings through various examples of embodiments.

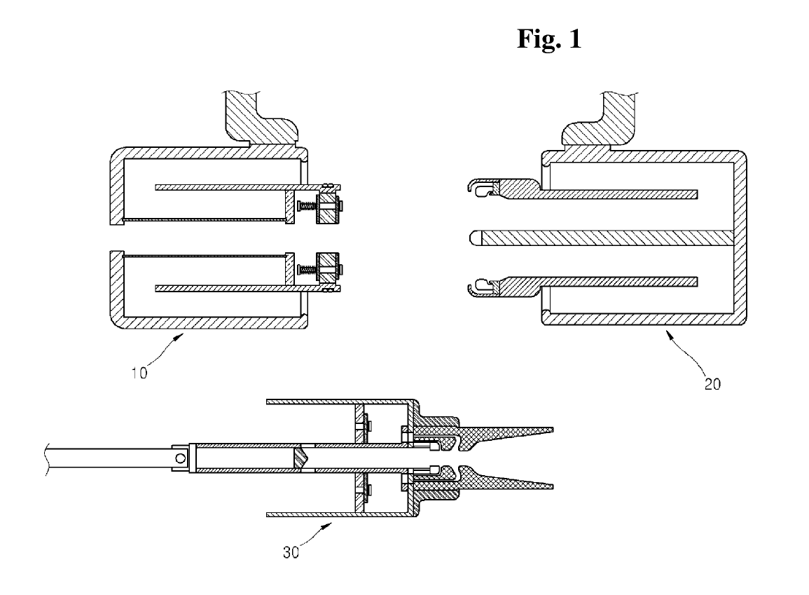

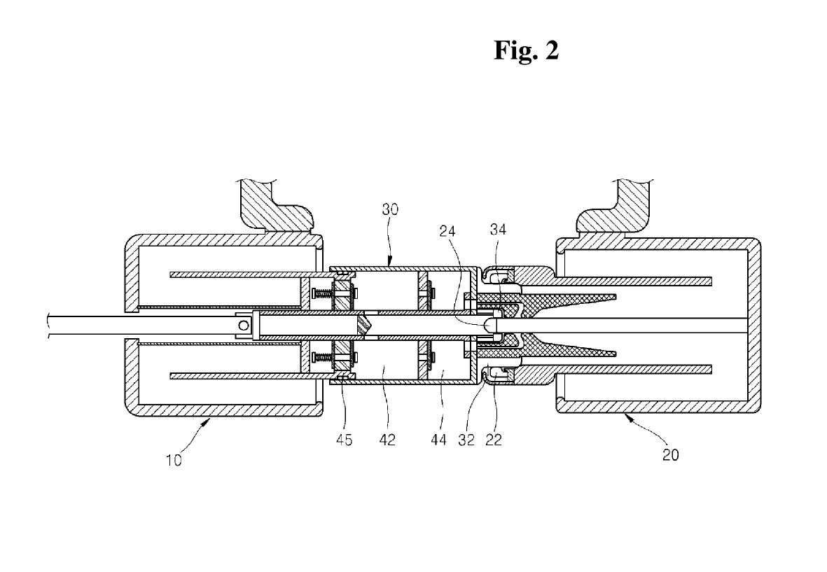

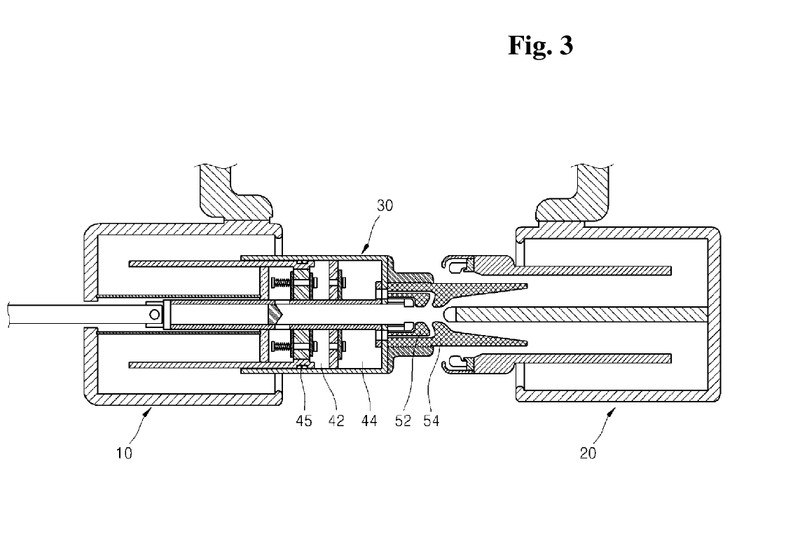

FIG. 1 is an exploded cross-sectional view illustrating the structure of a circuit breaker which is provided in a gas-insulated switchgear, FIG. 2 is a cross-sectional view illustrating the inserted state of the circuit breaker, and FIG. 3 is a cross-sectional view illustrating the interrupting state of the circuit breaker.

Referring to FIG. 1, a circuit breaker of a gas-insulated switch gear includes a movable part conductor 10 which is shown at the upper left portion of the drawing, a fixed part conductor 20 which is shown at the upper right portion of the drawing, and a movable rod part 30 which is shown at the lower portion of the drawing.

In an assembled state, the movable rod part 30 is slidingly moved in the state in which the movable rod part 30 is coupled to the movable part conductor 10, to be positioned in an inserted state and an interrupting state as shown in FIGS. 2 and 3, respectively.

The movable rod part 30 and the movable part conductor 10 maintain an electrically connected state regardless of the moved position of the movable rod part 30, whereas the movable rod part 30 and the fixed part conductor 20 are changed in an electrically connected state, according to the position of the movable rod part 30.

The inserted state will be described with reference to FIG. 2.

In the inserted state, a finger contact 22 of the fixed part conductor 20 is connected with a main contact 32 of the movable rod part 30, and a fixed arc contact 24 of the fixed part conductor 20 is connected with a movable arc contact 34 of the movable rod part 30. Accordingly, the fixed part conductor 20 and the movable part conductor 10 are connected through the movable rod part 30. In the inserted state, current of a normal state flows mainly through the finger contact 22 and the main contact 32.

A conversion process from the inserted state shown in FIG. 2 to the interrupting state shown in FIG. 3 will be described.

As an actuating shaft pulls the movable rod part 30 downward, the main contact 32 and the finger contact 22 are disconnected first, and then, the fixed arc contact 24 and the movable arc contact 34 are disconnected. When the fixed arc contact 24 and the movable arc contact 34 are disconnected, an arc is generated.

In order to interrupt the generated arc, an SF6 gas is used.

The SF6 gas is stored in a pressure chamber 42, and is compressed by a piston 45 as the movable rod part 30 is moved toward the movable part conductor 10. The compressed SF6 gas moves to a heat chamber 44 when the pressure of the compressed SF6 gas is equal to or higher than a predetermined pressure, and is then injected into a nozzle part.

The nozzle part is formed into a shape which surrounds the movable arc contact 34 of the movable rod part 30. The nozzle part includes a main nozzle 52 and an auxiliary nozzle 54, and the SF6 gas is injected into the space between the main nozzle 52 and the auxiliary nozzle 54.

When the SF6 gas accumulated in the heat chamber 44 is injected through the nozzle part to extinguish the arc, the injected SF6 gas becomes to have a high temperature and a high pressure, due to the arc generated upon interruption, and supersonic flow is created toward the fixed part conductor 20 and the movable part conductor 10. The high-temperature SF6 gas is abruptly degraded in its insulation performance, and the gas with degraded insulation performance may cause ground-to-ground and phase-to-phase dielectric breakdowns.

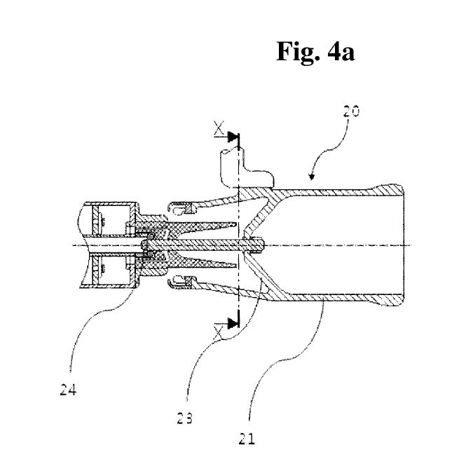

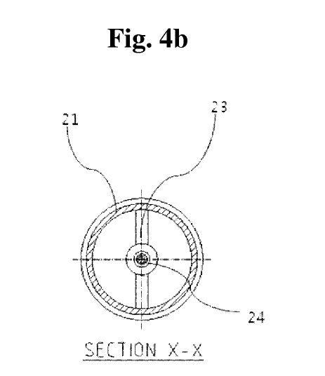

FIG. 4a and FIG. 4b are of cross-sectional views illustrating the structure of a conventional fixed part.

As shown in the drawing, a fixed arc contact 24 of a fixed part conductor 20 is disposed at the center of a fixed part conductor pipe 21 which has a cylindrical shape, and is connected to the fixed part conductor pipe 21 by supports 23.

If an arc is generated as the fixed arc contact 24 is disconnected as described above, a high-temperature and high-pressure extinction gas passes through the supports 23.

The fixed part conductor pipe 21 and the supports 23 may be integrally formed as shown or may be separately formed, and use mainly an aluminum alloy as their materials.

The high-temperature and high-pressure extinction gas, which passes through the supports 23, reaches a high temperature of 20,000° C. to 30,000° C. by the arc and is degraded in its insulation performance. Due to the extinction gas which becomes hot in this way, heat is directly transferred to the fixed part arc contact 24 and the supports 23.

In this regard, because the supports 23 are likely to be ablated due to the heat by the high-temperature and high-pressure extinction gas, the supports 23 should be disposed at a position that secures a predetermined distance from a main nozzle.

The supports 23 should be disposed in the state in which a minimal distance of 50 mm is secured from the end of the main nozzle when the arc is generated or a separation distance corresponding to 0.5 times the length of the main nozzle is secured. Otherwise, problems may be encountered in that, as the supports 23 are ablated by the high-temperature extinction gas, metal particles are likely to scatter in a circuit breaker to degrade interrupting performance.

If the necessary separation distance is secured, problems arise in that, as the length of the fixed part conductor 20 is increased, the overall length of the circuit breaker is increased.

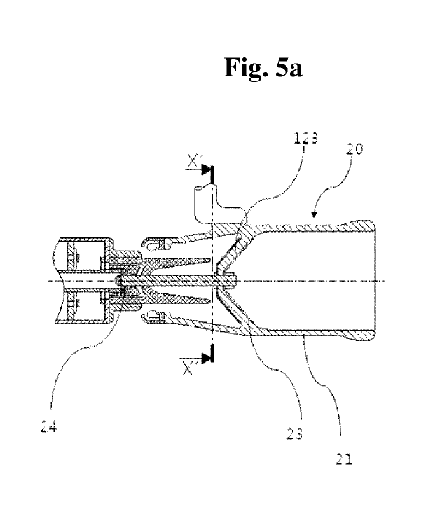

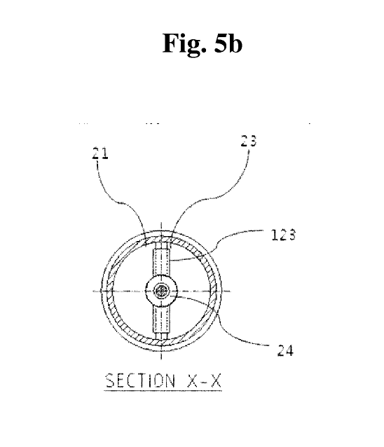

FIG. 5a and FIG. 5b are of cross-sectional views illustrating the structure of a conductor of a fixed part conductor in accordance with an embodiment.

As shown in the drawing, a fixed part conductor 20 according to the embodiment includes a fixed part conductor pipe 21 which has a cylindrical shape, a fixed part arc contact 24 which is fastened to the center shaft of the fixed part conductor pipe 21, supports 23 which fasten the fixed part arc contact 24 to the fixed part conductor pipe 21, and support shields 123 which cover the surfaces of the supports 23.

Each of the support shields 123 may be formed into a shape which covers the front surface of each support 23, facing an arc, and both side surfaces of each support 23.

Each of the support shields 123 is coupled in such a way as to be fitted from the front of each support 23. Although additional work is needed to cover the rear surface of each support 23, since heat transfer to the rear surface from the extinction gas is relatively small, the necessity to cover the rear surface by the support shield 123 may be less. The reason to this resides in that, because the extinction gas is injected with a high temperature and a high pressure and passes through the support 23 for a short time, heat transfer occurs most on the front surface, occurs next on both side surfaces, and occurs relatively small on the rear surface.

The support shields 123 may be formed of a material which has a melting point higher than the material of the supports 23 and is excellent in heat transfer. Although an aluminum alloy mainly used as the material of the supports 23 has a melting point of approximately 660° C. and may be easily ablated by the high-temperature and high-pressure extinction gas, when the support shields 123 are formed with a material which has a melting point higher than the aluminum alloy and an excellent heat conductivity, the support shields 123 may protect the supports 23. As a consequence, the ablation of the supports 23 may be prevented, and, because the heat transferred to the support shields 123 may be quickly transferred to the supports 23, the ablation of the support shields 123 may also be prevented.

As the material of the support shields 123, copper or steel may be used.

While it is illustrated in the embodiment that two supports 23 are disposed with an angle of 180°, it can be envisaged that one support may fasten the fixed part arc contact 24 or three supports may be disposed with an angle of 120° to fasten the fixed part arc contact 24.

When the supports 23 have these arrangements, the support shields 123 may be formed in conformity with the arrangements of the supports 23.

If the number of supports 23 is increased, although it is possible to firmly fasten the fixed part arc contact 24, because the supports 23 may impede the flow of the extinction gas, four or more supports may not be used.

The front surface of each of the supports 23 may have a round shape or a triangular cross-sectional shape. This is to ensure smooth flow of the extinction gas, and in this case, the support shields 123 may also be formed to correspond to the shape of the front surface of each support 23.

Both side surfaces of the support shield 123 may be formed to protrude from the rear surface of the support 23. In this case, when the high-temperature and high-pressure extinction gas passes, it is possible to decrease the amount of heat transferred to the rear surface of the support 23 from the high-temperature and high-pressure extinction gas as the high-temperature and high-pressure extinction gas stays on the rear surface of the support 23.

As is apparent from the above descriptions, according to the embodiment, advantages are provided in that, since a support shield is provided on a fixed-part arc contact support, it is possible to prevent the fixed-part arc contact support from being damaged by an arc.

Also, according to the embodiment, advantages are provided in that, since a fixed-part arc contact is prevented from being damaged by arc heat attributable to the presence of the support shield and thus the fixed-part arc contact support may be disposed at a position closer to an arc generation spot, the overall length of a fixed part may be decreased.

While various embodiments have been described above, it will be understood to those skilled in the art that the embodiments described are by way of example only. Accordingly, the disclosure described herein should not be limited based on the described embodiments.

What is claimed is:

1. A circuit breaker of a gas-insulated switchgear including a movable part conductor, a fixed part conductor, and a movable rod part which is moved between them to be positioned in an inserted state and an interrupting state, wherein the fixed part conductor comprises a fixed part conductor pipe which has a cylindrical shape, a fixed part arc contact which is fastened to a center shaft of the fixed part conductor pipe, a support which fastens the fixed part arc contact to the fixed part conductor pipe, and a support shield which covers a surface of the support.

2. The circuit breaker according to claim 1, wherein the support shield covers a front surface of the support which faces an arc, and both side surfaces of the support.

3. The circuit breaker according to claim 1, wherein two supports are disposed with an angle of 180°, or three supports are disposed with an angle of 120°.

4. The circuit breaker according to claim 1, wherein the support shield is formed of a material which has a melting point higher than a material of the support.

5. The circuit breaker according to claim 4,
wherein the support is formed of an aluminum alloy, and
wherein the support shield is formed of copper or steel.

6. The circuit breaker according to claim 1, wherein the front surface of the support has a round shape or a triangular cross-sectional shape.

7. The circuit breaker according to claim 6, wherein the support shield covers the front surface and both side surfaces of the support, in correspondence to the shape of the front surface.

8. The circuit breaker according to claim 1, wherein both side surfaces of the support shield are formed to protrude from a rear surface of the support.
